(19) United States
(12) Patent Application Publication
(10) Pub. No.: US 2010/0293143 A1
(43) Pub. Date: Nov. 18, 2010

(54) INITIALIZATION OF DATABASE FOR SYNCHRONIZATION

(75) Inventors: Maheshwar Jayaraman, Redmond, WA (US); Sudarshan A. Chitre, Redmond, WA (US); Lev Novik, Bellevue, WA (US); Philip D. Piwonka, Seattle, WA (US)

Correspondence Address: MICROSOFT CORPORATION, ONE MICROSOFT WAY, REDMOND, WA, 98052, US

(73) Assignee: Microsoft Corporation, Redmond, WA (US)

(21) Appl. No.: 12/464,894

(22) Filed: May 13, 2009

(51) Int. Cl. G06F 12/16; G06F 12/00

(52) U.S. Cl. 707/640; 711/E12.001; 711/E12.103; 707/803; 707/812; 711/1; 711/2; 711/3

(57) ABSTRACT

Aspects of the subject matter described herein relate to initializing a database to be used for synchronization. In aspects, a peer in a synchronization topology creates a consistent copy of its database. Metadata associated with this copy is marked to distinguish changes made before the copy was created from changes made after the copy was created and also that the copy needs to be prepared before being used in synchronization. Any client may then download the copy and start immediately reading and modifying its downloaded copy. Before the client synchronizes its copy with other databases already in the synchronization topology, the downloaded copy is prepared for use in the topology using the markers.

### BACKGROUND

With the multitude of devices available, there are more uses for synchronizing data. For example, a user may desire to have contacts on a mobile device synchronized with contacts in an e-mail application. The time it takes to initialize a database to participate in synchronization with another database may be substantial. During initialization one or more of the database involved in synchronization may be unavailable for other purposes. These costs and others may deter users from seeking to synchronize data.

The subject matter claimed herein is not limited to embodiments that solve any disadvantages or that operate only in environments such as those described above. Rather, this background is only provided to illustrate one exemplary technology area where some embodiments described herein may be practiced.

### SUMMARY

Briefly, aspects of the subject matter described herein relate to initializing a database to be used for synchronization. In aspects, a peer in a synchronization topology creates a consistent copy of its database. Metadata associated with this copy is marked to distinguish changes made before the copy was created from changes made after the copy was created and also that the copy needs to be prepared before being used in synchronization. Any client may download the copy and start immediately reading and modifying its downloaded copy. Before the client synchronizes its copy with other databases already in the synchronization topology, the downloaded copy is prepared for use in the topology using the markers.

This Summary is provided to briefly identify some aspects of the subject matter that is further described below in the Detailed Description. This Summary is not intended to identify key or essential features of the claimed subject matter, nor is it intended to be used to limit the scope of the claimed subject matter.

The phrase “subject matter described herein” refers to subject matter described in the Detailed Description unless the context clearly indicates otherwise. The term “aspects” is to be read as “at least one aspect.” Identifying aspects of the subject matter described in the Detailed Description is not intended to identify key or essential features of the claimed subject matter.

The aspects described above and other aspects of the subject matter described herein are illustrated by way of example and not limited in the accompanying figures in which like reference numerals indicate similar elements and in which:

### BRIEF DESCRIPTION OF THE DRAWINGS

FIG. 1 is a block diagram representing an exemplary general-purpose computing environment into which aspects of the subject matter described herein may be incorporated;

FIG. 2 is a block diagram representing an exemplary environment in which aspects of the subject matter described herein may be implemented;

FIG. 3 is a block diagram that generally represents an exemplary environment in which aspects of the subject matter described herein may be implemented;

FIG. 4 is a block diagram that represents an apparatus configured in accordance with aspects of the subject matter described herein; and

FIG. 5 is a flow diagram that generally represents exemplary actions that may occur creating a copy of a synchronized database in accordance with aspects of the subject matter described herein; and

FIG. 6 is a flow diagram that generally represents exemplary actions that may occur in preparing a database to become part of a synchronization topology in accordance with aspects of the subject matter described herein.

### DETAILED DESCRIPTION DEFINITIONS

As used herein, the term “includes” and its variants are to be read as open-ended terms that mean “includes, but is not limited to.” The term “or” is to be read as “and/or” unless the context clearly dictates otherwise. The term “based on” is to be read as “based at least in part on.” Other definitions, explicit and implicit, may be included below.

### Exemplary Operating Environment

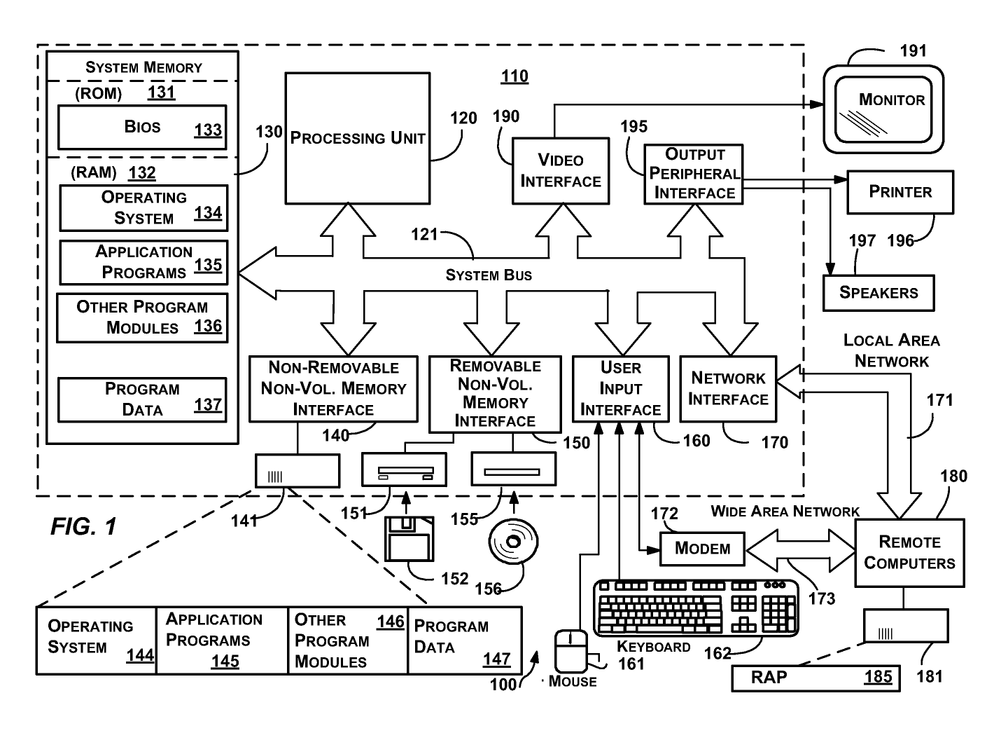

FIG. 1 illustrates an example of a suitable computing system environment 100 on which aspects of the subject matter described herein may be implemented. The computing system environment 100 is only one example of a suitable computing environment and is not intended to suggest any limitation as to the scope of use or functionality of aspects of the subject matter described herein. Neither should the computing environment 100 be interpreted as having any dependency or requirement relating to any one or combination of components illustrated in the exemplary operating environment 100.

Aspects of the subject matter described herein are operational with numerous other general purpose or special purpose computing system environments or configurations. Examples of well known computing systems, environments, or configurations that may be suitable for use with aspects of the subject matter described herein comprise personal computers, server computers, hand-held or laptop devices, multiprocessor systems, microcontroller-based systems, set top boxes, programmable consumer electronics, network PCs, minicomputers, mainframe computers, personal digital assistants (PDAs), gaming devices, printers, appliances including set-top, media center, or other appliances, automobile-embedded or attached computing devices, other mobile devices, distributed computing environments that include any of the above systems or devices, and the like.

Aspects of the subject matter described herein may be described in the general context of computer-executable instructions, such as program modules, being executed by a computer. Generally, program modules include routines, programs, objects, components, data structures, and so forth, which perform particular tasks or implement particular abstract data types. Aspects of the subject matter described herein may also be practiced in distributed computing environments where tasks are performed by remote processing devices that are linked through a communications network. In a distributed computing environment, program modules may be located in both local and remote computer storage media including memory storage devices.

With reference to FIG. 1, an exemplary system for implementing aspects of the subject matter described herein includes a general-purpose computing device in the form of a computer 110. A computer may include any electronic device that is capable of executing an instruction. Components of the computer 110 may include a processing unit 120, a system memory 130, and a system bus 121 that couples various system components including the system memory to the processing unit 120. The system bus 121 may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, Peripheral Component Interconnect (PCI) bus also known as Mezzanine bus, Peripheral Component Interconnect Extended (PCI-X) bus, Advanced Graphics Port (AGP), and PCI express (PCIe).

The computer 110 typically includes a variety of computer-readable media. Computer-readable media can be any available media that can be accessed by the computer 110 and includes both volatile and nonvolatile media, and removable and non-removable media. By way of example, and not limitation, computer-readable media may comprise computer storage media and communication media.

Computer storage media includes both volatile and nonvolatile, removable and non-removable media implemented in any method or technology for storage of information such as computer-readable instructions, data structures, program modules, or other data. Computer storage media includes RAM, ROM, EEPROM, flash memory or other memory technology, CD-ROM, digital versatile discs (DVDs) or other optical disk storage, magnetic cassettes, magnetic tape, magnetic disk storage or other magnetic storage devices, or any other medium which can be used to store the desired information and which can be accessed by the computer 110.

Communication media typically embodies computer-readable instructions, data structures, program modules, or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of any of the above should also be included within the scope of computer-readable media.

The system memory 130 includes computer storage media in the form of volatile and/or nonvolatile memory such as read only memory (ROM) 131 and random access memory (RAM) 132. A basic input/output system 133 (BIOS), containing the basic routines that help to transfer information between elements within computer 110, such as during start-up, is typically stored in ROM 131. RAM 132 typically contains data and/or program modules that are immediately accessible to and/or presently being operated on by processing unit 120. By way of example, and not limitation, FIG. 1 illustrates operating system 134, application programs 135, other program modules 136, and program data 137.

The computer 110 may also include other removable/non-removable, volatile/nonvolatile computer storage media. By way of example only, FIG. 1 illustrates a hard disk drive 141 that reads from or writes to non-removable, nonvolatile magnetic media, a magnetic disk drive 151 that reads from or writes to a removable, nonvolatile magnetic disk 152, and an optical disc drive 155 that reads from or writes to a removable, nonvolatile optical disc 156 such as a CD ROM or other optical media. Other removable/non-removable, volatile/nonvolatile computer storage media that can be used in the exemplary operating environment include magnetic tape cassettes, flash memory cards, digital versatile discs, other optical discs, digital video tape, solid state RAM, solid state ROM, and the like. The hard disk drive 141 is typically connected to the system bus 121 through a non-removable memory interface such as interface 140, and magnetic disk drive 151 and optical disc drive 155 are typically connected to the system bus 121 by a removable memory interface, such as interface 150.

The drives and their associated computer storage media, discussed above and illustrated in FIG. 1, provide storage of computer-readable instructions, data structures, program modules, and other data for the computer 110. In FIG. 1, for example, hard disk drive 141 is illustrated as storing operating system 144, application programs 145, other program modules 146, and program data 147. Note that these components can either be the same as or different from operating system 134, application programs 135, other program modules 136, and program data 137. Operating system 144, application programs 145, other program modules 146, and program data 147 are given different numbers herein to illustrate that, at a minimum, they are different copies.

A user may enter commands and information into the computer 20 through input devices such as a keyboard 162 and pointing device 161, commonly referred to as a mouse, trackball, or touch pad. Other input devices (not shown) may include a microphone, joystick, game pad, satellite dish, scanner, a touch-sensitive screen, a writing tablet, or the like. These and other input devices are often connected to the processing unit 120 through a user input interface 160 that is coupled to the system bus, but may be connected by other interface and bus structures, such as a parallel port, game port or a universal serial bus (USB).

A monitor 191 or other type of display device is also connected to the system bus 121 via an interface, such as a video interface 190. In addition to the monitor, computers may also include other peripheral output devices such as speakers 197 and printer 196, which may be connected through an output peripheral interface 190.

The computer 110 may operate in a networked environment using logical connections to one or more remote computers, such as a remote computer 180. The remote computer 180 may be a personal computer, a server, a router, a network PC, a peer device or other common network node, and typically includes many or all of the elements described above relative to the computer 110, although only a memory storage device 181 has been illustrated in FIG. 1. The logical connections depicted in FIG. 1 include a local area network (LAN) 171 and a wide area network (WAN) 173, but may also include other networks. Such networking environments are commonplace in offices, enterprise-wide computer networks, intranets, and the Internet.

When used in a LAN networking environment, the computer 110 is connected to the LAN 171 through a network interface or adapter 170. When used in a WAN networking environment, the computer 110 may include a modem 172 or other means for establishing communications over the WAN 173, such as the Internet. The modem 172, which may be internal or external, may be connected to the system bus 121 via the user input interface 160 or other appropriate mechanism. In a networked environment, program modules depicted relative to the computer 110, or portions thereof, may be stored in the remote memory storage device. By way of example, and not limitation, FIG. 1 illustrates remote application programs 185 as residing on memory device 181. It will be appreciated that the network connections shown are exemplary and other means of establishing a communications link between the computers may be used.

### Initialization

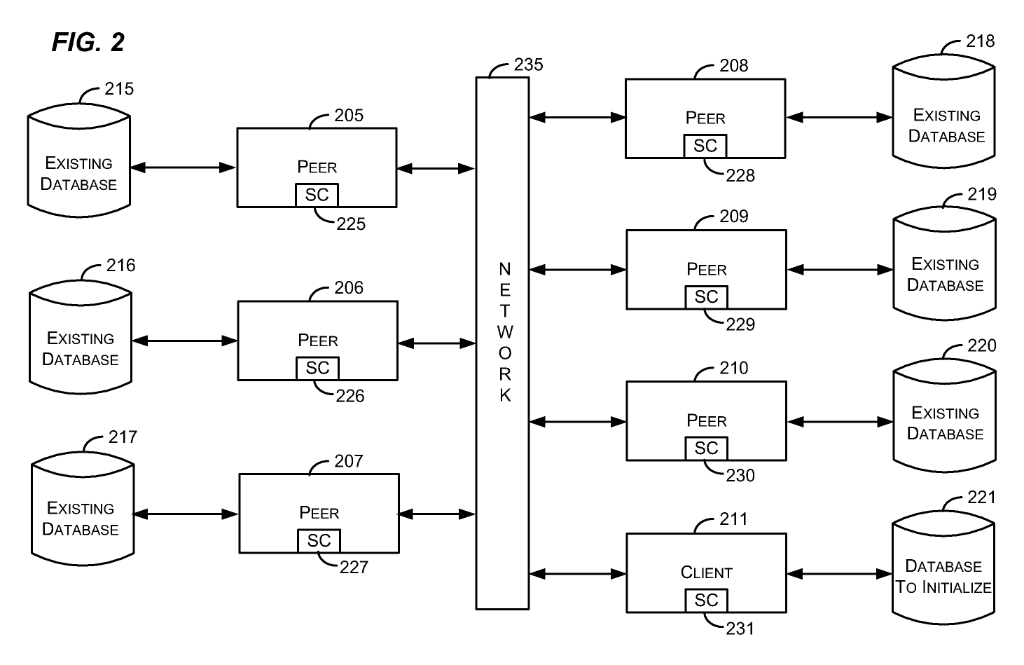

As mentioned previously, the costs associated with initializing a database to participate in synchronization with another database may deter users from deciding to synchronize the databases. FIG. 2 is a block diagram representing an exemplary environment in which aspects of the subject matter described herein may be implemented. The environment may include various peers 205-210, client 211, stores 215-221, a network 235, and may include other entities (not shown). Sometimes the peers 205-210 and the client 211 are referred to as entities. The entities 205-211 may include synchronizing components 225-231. The various entities may be located relatively close to each other or may be distributed across the world. The various entities may communicate with each other via various networks including intra- and inter-office networks and the network 235.

In an embodiment, the network 235 may comprise the Internet. In an embodiment, the network 235 may comprise one or more local area networks, wide area networks, direct connections, virtual connections, private networks, virtual private networks, some combination of the above, and the like.

Each of the entities 205-211 may comprise or reside on one or more computing devices. In some embodiments, two or more of the entities 205-211 may reside on a single computing device. Such devices may include, for example, personal computers, server computers, hand-held or laptop devices, multiprocessor systems, microcontroller-based systems, set top boxes, programmable consumer electronics, network PCs, minicomputers, mainframe computers, cell phones, personal digital assistants (PDAs), gaming devices, printers, appliances including set-top, media center, or other appliances, automobile-embedded or attached computing devices, other mobile devices, distributed computing environments that include any of the above systems or devices, and the like. An exemplary device that may be configured to act as a node comprises the computer 110 of FIG. 1.

Although the terms “client” and “peer” are sometimes used herein, it is to be understood, that a client or peer may be implemented on a machine that has hardware and/or software that is typically associated with a server, client, or otherwise. Furthermore, a client may at times act as a peer and vice versa. In an embodiment, a client and peer may, at various times, both be peers, servers, or clients. In one embodiment, two or more of the client 211 and/or the peers 205-210 may be implemented on the same physical machine.

The stores 215-221 comprise any storage media capable of storing data. The term data is to be read broadly to include anything that may be operated on by a computer. Some examples of data include information, program code, program state, program data, other data, and the like. A store may comprise a file system, database, volatile memory such as RAM, other storage, some combination of the above, and the like and may be distributed across multiple devices. A store may be external, internal, or include components that are both internal and external to the node to which the store is associated.

Data stored in the stores 215-221 may be organized in tables, records, objects, other data structures, and the like. The data may be stored in HTML files, XML files, spreadsheets, flat files, document files, and other files. Data stored on the stores 215-221 may be classified based on a model used to structure the data. For example, data stored on the stores 215-221 may comprise a relational database, object-oriented database, hierarchical database, network database, other type of database, some combination or extension of the above, and the like. As used herein, a database may include any type of data and may be stored in virtually any format including the formats indicated above.

Data in databases on a store may be accessed via components of a database management system (DBMS). A DBMS may comprise one or more programs that control organization, storage, management, and retrieval of data in a database. A DBMS may receive requests to access data in the database and may perform the operations needed to provide this access. Access as used herein may include reading data, writing data, deleting data, updating data, a combination including one or more of the above, and the like.

In describing aspects of the subject matter described herein, for simplicity, terminology associated with relational databases is sometimes used herein. Although relational database terminology is sometimes used herein, the teachings herein may also be applied to other types of databases including those that have been mentioned previously. As used herein, a record is to be read broadly as to include any data that may be included in a database of any type. For example, in a relational database, a record may comprise a row of a table.

The databases on the stores 215-220 may be associated with a synchronization topology. In this topology, pairs of databases periodically exchange information that may be used to update each other with the most recent changes. In synchronization, two databases management systems may establish a connection with each other and may then begin exchanging information about data that resides on each of their databases. Data that one database has that is more recent than what the other database has may be transferred to the other database and vice versa. Microsoft Sync Framework produced by Microsoft Corporation of Redmond, Wash., is a suitable framework for implementing synchronization in accordance with aspects of the subject matter described herein.

Each database may maintain metadata that indicates its knowledge of changes that have occurred on the other databases. This knowledge may be used during synchronization, for example, to determine which changes from one database are to be sent to the other database.

As illustrated in FIG. 2, the stores 215-220 include existing databases while the store 221 includes a database to initialize. In accordance with aspects of the subject matter described herein, the client 211 that is associated with the database to initialize may obtain data to initialize the database from any of the other databases or even from a store not illustrated in FIG. 2. This data may comprise a copy of a database that is maintained on one of the peers 205-210.

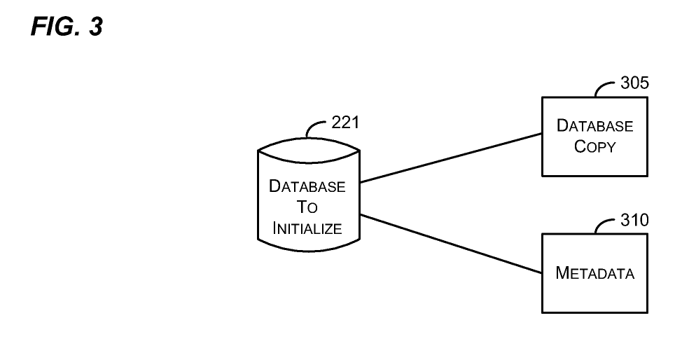

FIG. 3 is a block diagram that generally represents an exemplary environment in which aspects of the subject matter described herein may be implemented. The environment includes the store 221, a database copy 305, and metadata 310. The database copy 305 may be created from any of the databases on the stores 215-220. The metadata 310 includes the knowledge of updates for the database copy 305 and may also include other information as described below.

To create the database copy 305 a snapshot may be taken of any database in the synchronization topology. A snapshot is a copy of the database that is created at a time when the database is in a consistent state. The database may need to be frozen, taken offline, or made unavailable to changes while the snapshot is created, depending on the capabilities of the underlying store.

In conjunction with creating the snapshot, synchronization metadata associated with the database may also be copied and associated with the snapshot. In some embodiments, the metadata 310 may be included in a table of the database copy 305. In this embodiment, the act of creating the snapshot may also capture the metadata associated with the snapshot.

In conjunction with creating the snapshot or sometime after the snapshot is created but before additional changes are made to it, markers (e.g., data) may be added to the metadata 310 to indicate that the database copy 305 is a snapshot and to distinguish between changes made to the database before the snapshot and changes made to the database after the snapshot. The markers may be added by the peer from which the snapshot is taken, by a client downloading a copy of the database, or by some other entity without departing from the spirit or scope of aspects of the subject matter described herein.

A database created from the database copy 305 is not to be used in synchronization until certain actions, described below, are taken. The markers may also indicate a logical time the snapshot was taken. A logical time may include a time indicated by a clock, a timestamp, a current count of an increasing counter, other data that indicates when the snapshot was taken, data that indicates a time after the snapshot was taken but before any modifications have been made, data that indicates an event, and the like. These markers may later be used to distinguish changes made before and after the snapshot generation process.

Any client seeking to join the synchronization topology may first obtain a copy of the snapshot. After obtaining the copy, the client may point its DBMS at the copy to indicate that the copy is to be used for the database of the DBMS. Once the DBMS is associated with the copy, the client may read and make local changes to the copy without any additional preparation steps and before synchronization.

In conjunction with synchronizing the copy of the database for the first time with another peer of the synchronization topology, the markers in the metadata may be used to initialize the database to be part of the synchronization topology. In particular, the presence of markers indicates that the database needs to be initialized prior to joining the synchronization topology. In initializing the database, the following actions may be performed.

1. A new identifier is generated to represent a new peer in the synchronization topology.

2. The knowledge metadata is modified to include the newly generated identifier as a known peer. In this step, an identifier of the snapshot-generating peer may also be modified in the knowledge metadata in preparation for subsequent synchronization activity. For example, in one embodiment, an ID of 0 may refer to knowledge about a peer's own data while other IDs may refer to knowledge about data on other peers. In this case, data already in the snapshot may be referred to with an ID of 0. The ID of 0, however, reflects knowledge about the snapshot-generating peer not the new peer. In this case, in the knowledge of the new peer, the snapshot-generating peer may be modified to, for example, an ID that is larger than other IDs in the knowledge. Records associated with 0 may then be associated with this modified ID as indicated below.

3. Using a marker that indicates when the snapshot was created, in the new database, all records whose metadata points to the old identifier of the peer that generated the snapshot are identified.

4. The metadata for all identified records is fixed so that the metadata is associated with the modified identifier (from step 2) of the snapshot-generating peer. This is done so that it is recognized that there records were added or changed by the snapshot-generating peer.

5. Using the marker that indicates when the snapshot was created, in the new database, all records that were added or modified after the snapshot was created are identified.

6. For all identified records, metadata is fixed or added, so that the identified records are associated with the new local peer identifier generated in step 1. This is done so that it is recognized that these records were added or modified by the new peer.

7. The knowledge is saved into the metadata table and all snapshot markers are removed.

This process ensures that the metadata is fixed or added only for those rows that either belonged to the snapshot-generating peer or were made by the new peer. Also since the data already exists in the database, fixing up existing metadata involves a simple update query. After initialization, the new client only synchronizes changes (local and remote) that happened after the snapshot was generated.

Although the environments described above includes various numbers of the entities and related infrastructure, it will be recognized that more, fewer, or a different combination of these entities and others may be employed without departing from the spirit or scope of aspects of the subject matter described herein. Furthermore, the entities and communication networks included in the environment may be configured in a variety of ways as will be understood by those skilled in the art without departing from the spirit or scope of aspects of the subject matter described herein.

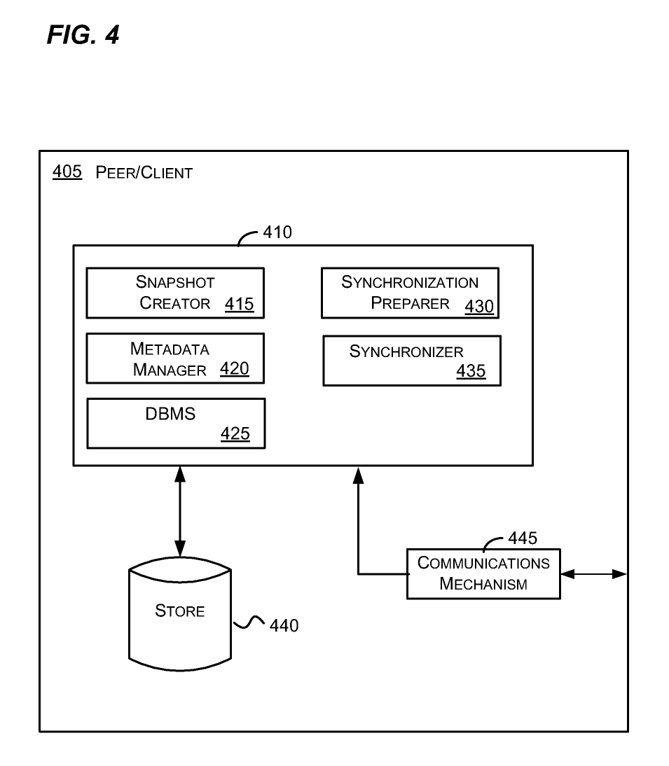

FIG. 4 is a block diagram that represents an apparatus configured in accordance with aspects of the subject matter described herein. The components illustrated in FIG. 4 are exemplary and are not meant to be all-inclusive of components that may be needed or included. In other embodiments, the components and/or functions described in conjunction with FIG. 4 may be included in other components (shown or not shown) or placed in subcomponents without departing from the spirit or scope of aspects of the subject matter described herein. In some embodiments, the components and/or functions described in conjunction with FIG. 4 may be distributed across multiple devices.

Turning to FIG. 4, the peer/client 405 may include synchronizing components 410, a store 440, a communications mechanism 445, and other components (not shown). The peer/client 405 may be implemented on or as a computer (e.g., as the computer 110 of FIG. 1).

The synchronizing components 410 correspond to the synchronizing components 225-231 of FIG. 2. The synchronizing components 410 may include a snapshot creator 415, a metadata manager 420, a database management system 425, a synchronization preparer 430, a synchronizer 435, and may also include other components (not shown). As used herein, the term component is to be read to include all or a portion of a device, one or more software components executing on one or more devices, some combination of one or more software components and one or more devices, and the like.

The communications mechanism 445 allows the peer/client 405 to communicate with other entities (e.g., the entities 205-211 of FIG. 2). The communications mechanism 445 may be a network interface or adapter 170, modem 172, or any other mechanism for establishing communications as described in conjunction with FIG. 1.

The store 440 is any storage media capable of storing data. In particular, the store 440 may provide access to a copy of a database. When the store 440 is associated with a peer (e.g., one of the peers 205-210 of FIG. 2), the database on the store may be associated with a synchronization topology configured such that at least part of the database is periodically synchronized with one or more other databases in the synchronization topology. When the store 440 is associated with a client, the store 440 may provide access to a copy of one of the peer's databases. The store 440 corresponds to the stores 215-221 of FIG. 2 and may be used in a similar way as the stores 215-221 as described previously.

The snapshot creator 415 is operable to create a snapshot of a database of a peer. The snapshot creator 415 ensures that the snapshot is consistent and may need to temporarily halt database activities to obtain a consistent image of the database. The snapshot creator 415 may comprise file system components that create snapshots, a mirrored-disk system that can create snapshots, another mechanism for creating snapshots, and the like.

The metadata manager 420 is operable to detect markers in metadata associated with the copy. When the markers are present they indicate a logical time at which the copy was created and also indicating that additional work is needed before the copy is synchronized via the synchronization topology. The metadata manager 420 may be further operable to add the markers to metadata associated with the copy in conjunction with the copy being created by one of the peers.

The database management system (DBMS) 425 may provide access to a database stored on the store 440. The DBMS 425 may provide access to the database whether or not metadata associated with the database includes markers that indicate whether the database has been initialized for synchronization within a synchronization topology.

The synchronizer preparer 430 is operable to generate an identifier to represent a new peer in the synchronization topology and to associate with the identifier metadata associated with data created or updated in the copy after the logical time. The synchronizer preparer 430 may be further operable to associate update metadata with a peer that provided the copy. The update metadata is associated with data that was created or updated by the peer before the copy was created.

The synchronizer 435 is operable to synchronize a database stored on the store 440 with one or more other databases in a synchronization topology such as that illustrated in FIG. 2. The synchronizer 435 may use knowledge of changes to determine whether its database includes the most up-to-date changes.

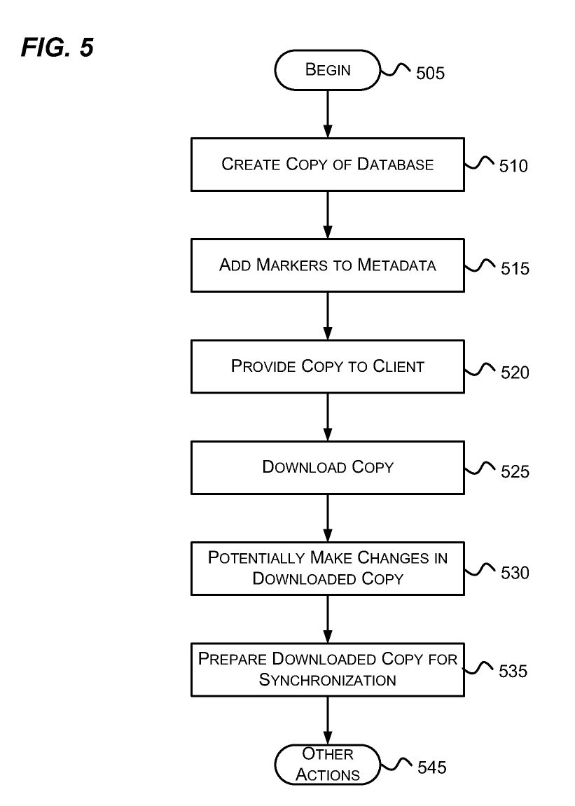

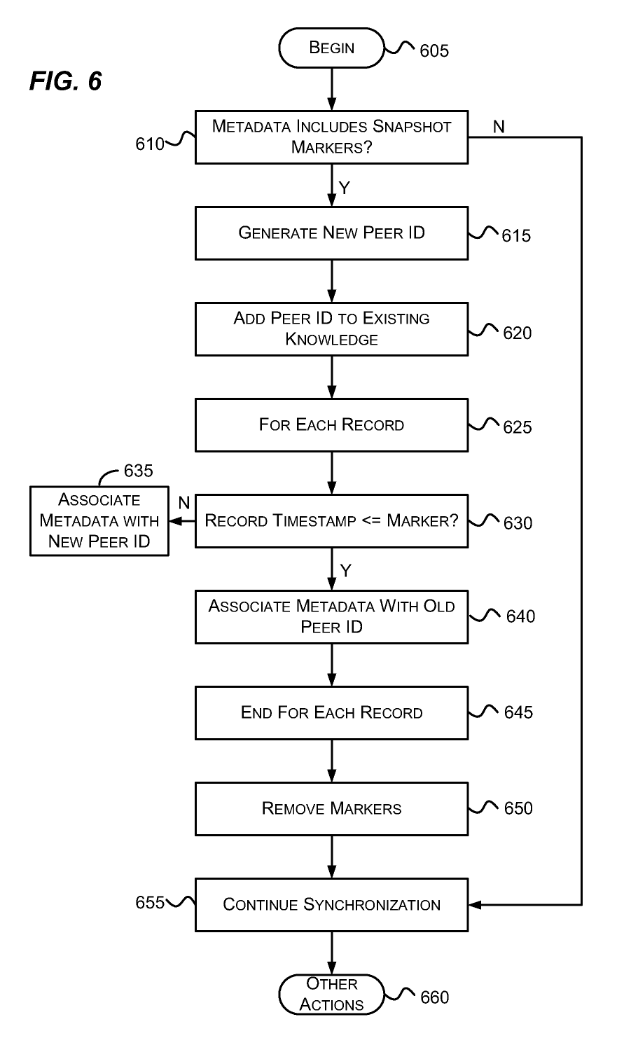

FIGS. 5-6 are flow diagrams that generally represent actions that may occur in accordance with aspects of the subject matter described herein. For simplicity of explanation, the methodology described in conjunction with FIGS. 5-6 is depicted and described as a series of acts. It is to be understood and appreciated that aspects of the subject matter described herein are not limited by the acts illustrated and/or by the order of acts. In one embodiment, the acts occur in an order as described below. In other embodiments, however, the acts may occur in parallel, in another order, and/or with other acts not presented and described herein. Furthermore, not all illustrated acts may be required to implement the methodology in accordance with aspects of the subject matter described herein. In addition, those skilled in the art will understand and appreciate that the methodology could alternatively be represented as a series of interrelated states via a state diagram or as events.

FIG. 5 is a flow diagram that generally represents exemplary actions that may occur creating a copy of a synchronized database in accordance with aspects of the subject matter described herein. Turning to FIG. 5, at block 505, the actions begin.

At block 510, a copy of the database is created. For example, referring to FIG. 2, the peer 210 may create a snapshot of the database stored on the store 220. This database is associated with a synchronization topology that includes the other peers 205-209, such that at least part of the database is periodically synchronized with one or more other databases in the synchronization topology.

At block 515, markers are added to metadata associated with the copy. For example, referring to FIG. 4, the metadata manager 420 may add markers that indicate a logical time at which the snapshot was created as well as indicating that additional work is needed before the copy is synchronized via the synchronization topology. As another example, referring to FIG. 2, the client 211 may add markers that indicate a logical time at which the copy was created. These markers may indicate that the logical time at which the copy was created is before the logical time indicated by the markers.

At block 520, the copy and metadata are provided to one or more clients for use that includes becoming part of the synchronization topology. For example, referring to FIG. 2, the copy is provided to the client 211. Note that the actions associated with blocks 515 and 520 may be reversed. In other words, the copy and metadata may be provided to the one or more clients that may then add the markers after they have received the copy and metadata.

At block 525, the client downloads the copy to create a downloaded copy. For example, referring to FIG. 2, the client 211 may download the copy to create a downloaded copy on the store 221. In addition, the client 211 may indicate that a database management system is to use the downloaded copy for database activities. The client may then immediately access the downloaded copy via the database management system without additional changes made to the downloaded copy before the accessing.

At block 530, the client may access the downloaded copy. Accessing the downloaded copy may include one or more of reading data within the downloaded copy, changing data within the downloaded copy, adding data to the downloaded copy, and deleting data within the downloaded copy. When data is modified in the downloaded copy, metadata may be updated to account for the modifications.

At block 535, the downloaded copy is prepared for synchronization. This may include, for example, generating an identifier to represent a new peer in the synchronization topology and modifying metadata. For changes made after the time the copy was made, the metadata may be modified/added to be associated with the new identifier. With data created or updated prior to the time the copy was made, the metadata may be associated with the identifier of the entity from which the copy was created. For example, referring to FIG. 4, the synchronization preparer 430 may utilize the metadata manager 420 to change metadata within the downloaded copy of the database. In addition, the synchronization preparer 430 may remove the markers from the downloaded copy such that subsequent synchronization activity skips preparing the downloaded copy to be synchronized.

At block 540, other actions, if any, may be performed.

FIG. 6 is a flow diagram that generally represents exemplary actions that may occur in preparing a database to become part of a synchronization topology in accordance with aspects of the subject matter described herein. Prior to the actions illustrated in FIG. 6, a client may obtain a copy of a database that is associated with a synchronization topology as described previously. Turning to FIG. 6, at block 605, the actions begin.

At block 610, a determination is made as to whether the metadata includes markers. If so, the actions continue at block 615; otherwise, the actions continue at block 655.

At block 615, an identifier to represent a new peer in the synchronization topology is generated. The new peer (formerly called the client) is associated with the copy of the database. For example, referring to FIG. 4, the synchronization preparer 430 generates a new peer ID.

At block 620, the peer ID is added to the existing knowledge of changes that have occurred on the other databases. For example, referring to FIG. 4, the synchronization preparer 430 may add the peer ID to a data structure that includes knowledge of updates of changes that have occurred on other databases.

Actions associated with various of the blocks refer to records that are currently owned by the snapshot generating peer. These actions may be performed for each record of the copy that is to be synchronized with other databases of the synchronization topology. In a relational database, records from one or more tables may be configured to be synchronized with other databases of the synchronization topology.

At block 630, a determination is made as to whether a logical time associated with a record is less than or equal to a marker that indicates a logical time at which the copy was created. If the logical time of the record is less, the actions continue at block 640; otherwise, the actions continue at block 640.

At block 635, because the record was created or updated at a time greater than the marker, the metadata associated with the record is also associated with the identifier of the new peer ID as the new peer created or updated the record. After block 635 if another record exists, the actions continue at block 625; otherwise, the actions continue at block 650.

At block 640, because the record was created or updated at a time less than the marker, the metadata associated with the record is also associated with the identifier of the old peer ID (i.e., the peer ID of the peer that generated the snapshot) as the old peer created or updated the record.

At block 645, if another record exists, the actions continue at block 625; otherwise, the actions continue at block 650.

At block 650, the markers are removed. For example, referring to FIG. 4, the synchronization preparer 430 may use the metadata manager 420 to remove markers from the metadata.

At block 655, synchronization between the databases may occur. For example, referring to FIG. 2, the client 211 may synchronize the now initialized database stored on the store 221 with one of the databases stored on the stores 215-220.

At block 660, other actions, if any, may be performed.

As can be seen from the foregoing detailed description, aspects have been described related to multi-log based replication. While aspects of the subject matter described herein are susceptible to various modifications and alternative constructions, certain illustrated embodiments thereof are shown in the drawings and have been described above in detail. It should be understood, however, that there is no intention to limit aspects of the claimed subject matter to the specific forms disclosed, but on the contrary, the intention is to cover all modifications, alternative constructions, and equivalents falling within the spirit and scope of various aspects of the subject matter described herein.

What is claimed is:

1. A method implemented at least in part by a computer, the method comprising:
obtaining a copy of a database, the database associated with a synchronization topology configured to periodically synchronize at least part of the database with one or more other databases in the synchronization topology, the copy associated with metadata that has been modified to include markers that indicate a logical time at which the copy was created, the markers also indicating that additional work is needed before the copy is synchronized via the synchronization topology; and
in conjunction with preparing the copy to be synchronized via the synchronization topology, performing additional actions, comprising:
generating an identifier to represent a new peer in the synchronization topology, the new peer associated with the copy; and
for data created or updated in the copy after the logical time, associating metadata associated with the data also with the identifier to indicate that the data was created or updated by the new peer.

2. The method of claim 1, further comprising before preparing the copy to be synchronized via the synchronization topology, allowing changes to be made to data within the copy.

3. The method of claim 1, further comprising reading data from the copy via a database management system in response to database access requests directed to the copy prior to preparing the copy to be synchronized via the synchronization topology.

4. The method of claim 1, wherein the copy of the database includes the metadata in a table of the database.

5. The method of claim 1, wherein associating metadata associated with the data also with the identifier comprises for each record of the copy that was created or updated after the logical time, inserting or updating a row in a table to include a reference to the metadata and a reference to the record.

6. The method of claim 1, further comprising for data created or updated in the copy before the logical time, associating metadata with an identifier of an entity that created the copy, the entity being part of the synchronization topology.

7. The method of claim 1, further comprising removing the markers from metadata to indicate that the copy is prepared to participate in synchronization via the synchronization topology.

8. The method of claim 1, further comprising after preparing the copy to be synchronized via the synchronization topology, synchronizing changes included in the copy that occurred after the logical time at which the copy was created but before preparing the copy to be synchronized via the synchronization topology.

9. A computer storage medium having computer-executable instructions, which when executed perform actions, comprising:
creating a copy of a database, the database associated with a synchronization topology configured to periodically synchronize at least part of the database with one or more other databases in the synchronization topology;
providing the copy and metadata associated with the copy to one or more clients for use that includes becoming part of the synchronization topology; and
adding markers to the metadata, the markers indicating a logical time at which the copy was created and also indicating that additional work is needed before the copy is synchronized via the synchronization topology.

10. The computer storage medium of claim 9, further comprising downloading the copy and creating a downloaded copy therewith, indicating to a database management system that the database management system is to use the downloaded copy for database activities, and accessing the downloaded copy via the database management system without additional changes made to the downloaded copy before the accessing.

11. The computer storage medium of claim 10, wherein accessing the downloaded copy via the database management system comprises, via the database management system, one or more of reading data within the downloaded copy, changing data within the downloaded copy, adding data to the downloaded copy, and deleting data within the downloaded copy.

12. The computer storage medium of claim 11, further comprising updating the metadata to account for modifications made to the downloaded copy.

13. The computer storage medium of claim 9, wherein creating a copy of a database comprises creating a copy of the database that includes the metadata in a table of the database.

14. The computer storage medium of claim 9, further comprising in conjunction with preparing the downloaded copy to be synchronized via the synchronization topology, performing additional actions, comprising:
generating an identifier to represent a new peer in the synchronization topology, the new peer associated with the downloaded copy; and
for data created or updated in the downloaded copy after the logical time, associating metadata associated with the data also with the identifier to indicate that the data was created or updated by the new peer.

15. The computer storage medium of claim 14, further comprising for data created or updated prior to the logical time, associating metadata associated with the data with an entity from which the copy was created, the synchronization topology including the entity.

16. The computer storage medium of claim 9, further comprising removing the markers from a downloaded copy of the copy such that subsequent synchronization activity skips preparing the downloaded copy to be synchronized.

17. In a computing environment, an apparatus, comprising:
a store operable to store a copy of a database, the database associated with a synchronization topology configured to periodically synchronize at least part of the database with one or more other databases in the synchronization topology;
a metadata manager operable to detect markers in metadata associated with the copy, the markers, when present, indicating a logical time at which the copy was created and also indicating that additional work is needed before the copy is synchronized via the synchronization topology; and
a synchronizer preparer operable to generate an identifier to represent a new peer in the synchronization topology and to associate with the identifier metadata associated with data created or updated in the copy after the logical time.

18. The apparatus of claim 17, wherein the metadata manager is further operable to add the markers to metadata associated with the copy in conjunction with the copy being created.

19. The apparatus of claim 17, further comprising a database management system operable to access the copy of the database together with the markers and to make changes to the copy before the copy is associated with the synchronization topology.

20. The apparatus of claim 17, wherein the synchronizer preparer is further operable to associate update metadata with a peer that provided the copy, the update metadata associated with data in the copy that was created or updated by the peer before the logical time.
